(19) United States
(12) Patent Application Publication
(10) Pub. No.: US 2004/0222306 A1
(43) Pub. Date: Nov. 11, 2004

(54) Methods, systems and apparatus for displaying bonsai trees

(76) Inventor: Anthony Fajarillo, Maple Valley, WA (US)

Correspondence Address: DAVID W. C. CHEN, P.O. Box 3041, SEATTLE, WA, 98114-3041, US

(21) Appl. No.: 10/840,842

(22) Filed: May 7, 2004

Related U.S. Application Data
(60) Provisional application No. 60/469,119, filed on May 8, 2003.

(51) Int. Cl. G05D 23/00; A47F 3/04; F25B 49/00; F25D 17/04

(52) U.S. Cl. 236/44 B; 236/44 C; 62/246; 62/176.1

(57) ABSTRACT

Apparatus, systems and methods for displaying plant life, such as bonsai trees. In one embodiment, the display system includes a climate control system capable of controlling temperature, light intensity, and humidity in a display case containing plant life. The climate control system can be connected to a communication network for receiving climate control input information. The input information can be signals usable to control climate in the display case as a function of climate in a remote location.

### CROSS-REFERENCE TO RELATED APPLICATION(S)

This application claims the benefit of U.S. Provisional Patent Application No. 60/469,119 filed May 8, 2003, which is incorporated herein by reference in its entirety.

### BACKGROUND OF THE INVENTION

1. Field of the Invention

The present invention relates to climate controlled display systems, methods and apparatus for plant life.

2. Description of Related Art

The art of bonsai involves the cultivation, pruning, shaping and training of a tree or shrub into a desired shape. The resulting plants are often highly valued because of the artistry and the time consuming processes involved in developing them into bonsai trees.

The beauty of bonsai trees is often attained only with great attention and care. Some believe that the same care should be exercised in displaying the trees. Bonsai trees are mostly outdoors and can often only be viewed indoors for a limited period of time before the tree is stressed and eventually dies. Some reasons for this include improper temperature, humidity, air circulation and lighting. Although some trees can be maintained indoors for longer periods of time, other trees, such as those that grow in regions with four (4) seasons cannot be kept indoors for long periods of time. Nonetheless, people often spend much of their time indoors and enjoy viewing bonsai trees indoors. For example, having bonsai trees indoors can add significant aesthetic beauty to the setting of a home or other building. Also, artistic displays are often held indoors for long periods of time and as bonsai continues to earn the status of an art, it becomes more beneficial to be able to show the trees indoors for longer periods of time. There is a need for a method, apparatus and system for maintaining bonsai trees indoors for longer periods of time while reducing the risk to the trees.

### BRIEF SUMMARY OF THE INVENTION

In some embodiments of the invention a display case is provided. The display case can be supported atop a cabinet. The cabinet can house a climate control system for controlling climate within the display case.

Some of the climate parameters controlled can include, without limitation, temperature, air circulation rate, humidity, and light intensity. The temperature can be controlled by controlling hot air or cool air flow rates through the display case. A thermoelectric cooling device can be used to cool air. A heat sink for the thermoelectric cooling device can also serve to heat the hot air. Air circulation rate can be controlled by adjusting a fan rpm rate. Humidity can be controlled by controlling a rate of water injection into the circulating air. Light intensity and wavelength can be controlled using various means such as regulating the light electrically, including shutting off light and moving the position of light sources, or mechanically, by placing colored lenses over the light to control wavelength and intensity.

In some embodiments of the present invention, the climate control system is coupled to a communication network, such as the Internet, and can receive climate data therefrom. The climate data can be real time remote climate data from various regions around the globe. The climate control system has a processor and can accept the real time remote data as a set point for controlling climate within the display case. That is, it can mimic the remote climate conditions where a subject tree came from. Alternatively, the climate control system can accept the remote climate data as input data and control the climate as a function of such data.

### BRIEF DESCRIPTION OF SEVERAL VIEWS OF THE DRAWINGS

FIG. 1a is a perspective view of an embodiment of the display assembly of the present invention.

FIG. 1b is the display assembly of FIG. 1a with a bonsai tree disposed within the display case.

FIG. 2 is a partial perspective view of an embodiment of the display assembly of the present invention showing a frame for the display case and light bars attached to a top portion of the frame.

FIG. 3 is the display case of FIG. 2 with the addition of a curved overhead canopy.

FIG. 4 is a detail side elevational view of a light bar used with the display assemblies of FIG. 2 and FIG. 3.

FIG. 5 is the display assembly of FIG. 1 with the addition of an exterior light fixture and lamp.

FIG. 6 is a simplified process and control diagram of an embodiment of the climate control system of the present invention.

### DETAILED DESCRIPTION OF VARIOUS EMBODIMENTS OF THE INVENTION

In the following description, certain specific details are set forth in order to provide a thorough understanding of various embodiments of the invention. However, upon reviewing this disclosure one skilled in the art will appreciate that the invention may be practiced without many of these details. In other instances, well-known structures associated with control systems and display cabinets or cases have not been described in detail to avoid unnecessarily obscuring the descriptions of the embodiments of the invention.

The term “conduit” as used herein, can refer to, inter alia, any channel or duct through which fluid, such as air or water can be conveyed, including, but not limited to, rectangular air ducts, pipe, tube, and hose. The term “processor” as used herein, can refer to, inter alia, a processor, controller or microcontroller. The term “plant” as used herein, can refer to plants or trees. The terms above are to be construed as has been defined unless the context indicates otherwise.

Many embodiments of the invention described herein are described in the context of application to bonsai trees. However, as one skilled in the art will appreciate, many of these embodiments have application beyond bonsai trees and can be used for other plants and animal life. The described applications are not intended to be restrictive in meaning.

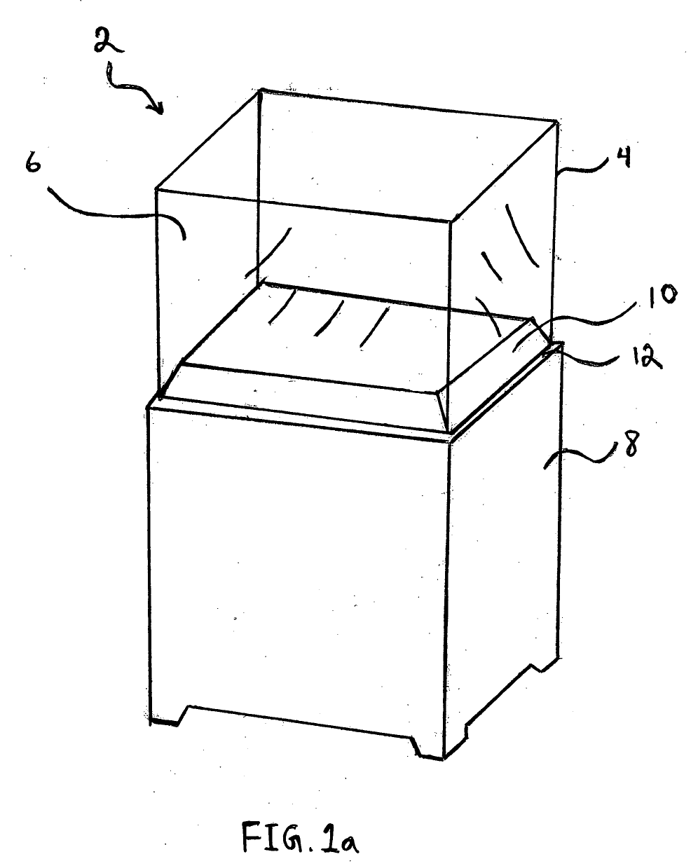

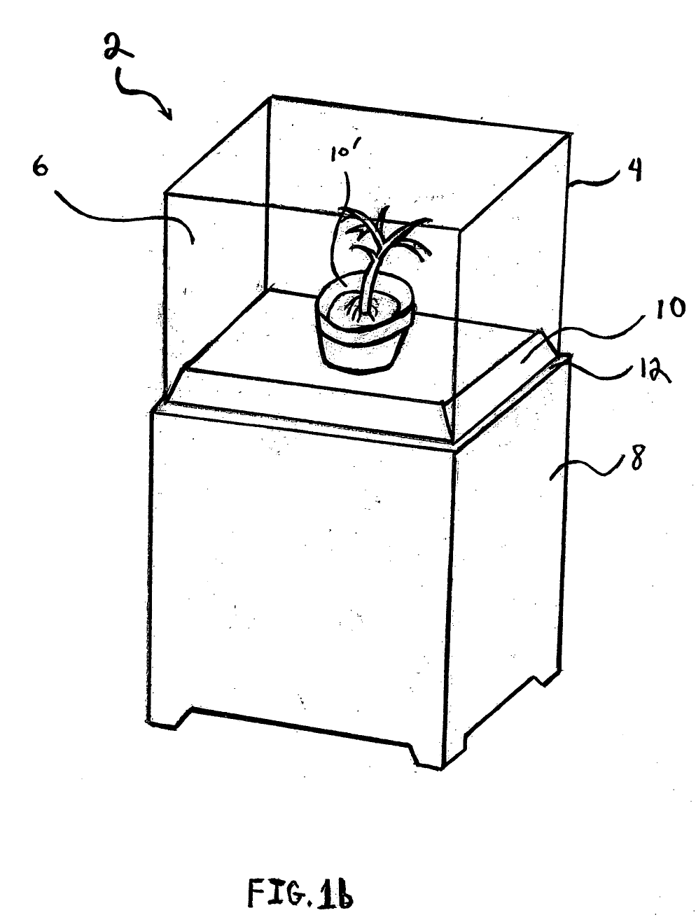

As shown in FIG. 1a, some embodiments of the present invention include a display assembly 2 with a display case 4 having transparent walls 6. In the illustrated embodiment of FIG. 1a, the display case 4 is cubically shaped but can be any of a plurality of sizes and shapes in various embodiments, such as, for example, semi-spherical (not shown). The transparent walls 6 of the display case 4 can be double pane glass filled with argon gas.

FIG. 1a also depicts a cabinet 8 upon which the display case 4 rests. In addition, a platform 10 can be provided within the display case 4. The platform can be raised above a top surface 12 of the cabinet 8 for placement of a bonsai tree 10′ or other plant. See FIG. 1b.

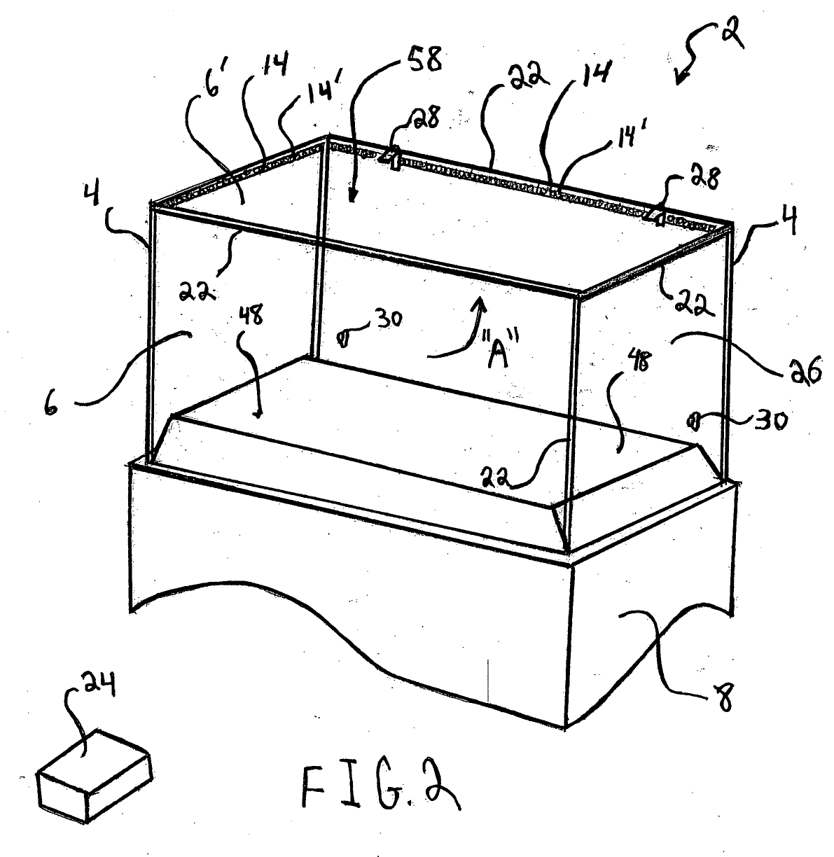

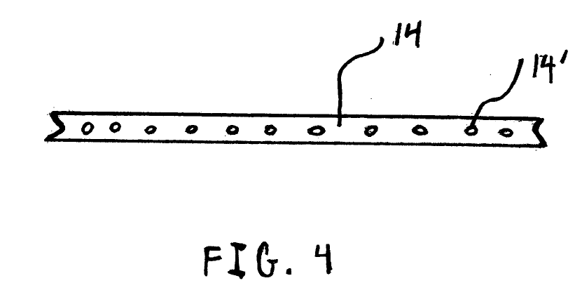

In other embodiments, such as that shown in FIG. 2, the display case 4 contains fiber optic lighting. In the illustrated embodiments of FIG. 2 and FIG. 4, the fiber optic lighting comprises light bars 14, with optical fibers 14′ threaded therethrough. The ends of the optical fibers 14′ can be seen to face outward away from the light bars 14, as depicted in FIG. 4. The light bars 14 can be disposed on frame members 22 of the display case 4. FIG. 2. A remote light source 24 is shown in FIG. 2 and can be connected to the optical fibers for providing light thereto. In some embodiments, the remote light source 24 is enclosed within the cabinet 8 (not shown inside the cabinet in the Figures). The location of the remote light source 24 away from the display case 4 can reduce heat load placed on the interior of the display case 4. Furthermore, if the remote light source 24 is contained in the cabinet, it can be insulated from the display case 4 to reduce heat transfer to the display case 4.

As will be appreciated by one skilled in the art after reading the present disclosure, the fiber optic lighting within the display case 4 can provide low-heat high-illumination lighting. This can reduce heat stress on bonsai trees in the display case 4 while providing brilliant illumination. Also, the use of fiber optic lighting within the display case 4 lowers potential temperature control interference that could otherwise occur when using other higher heat light sources, such as placing metal halide bulbs directly above the display case 4.

Although the fiber optic lighting is illustrated as light bars 14 in FIG. 2, other fiber optic lighting configurations can also be used. These examples include, but are not limited to, individual fiber optic strands or bundles attached to the display case 4 in any of various configurations and locations, on or within the display case 4.

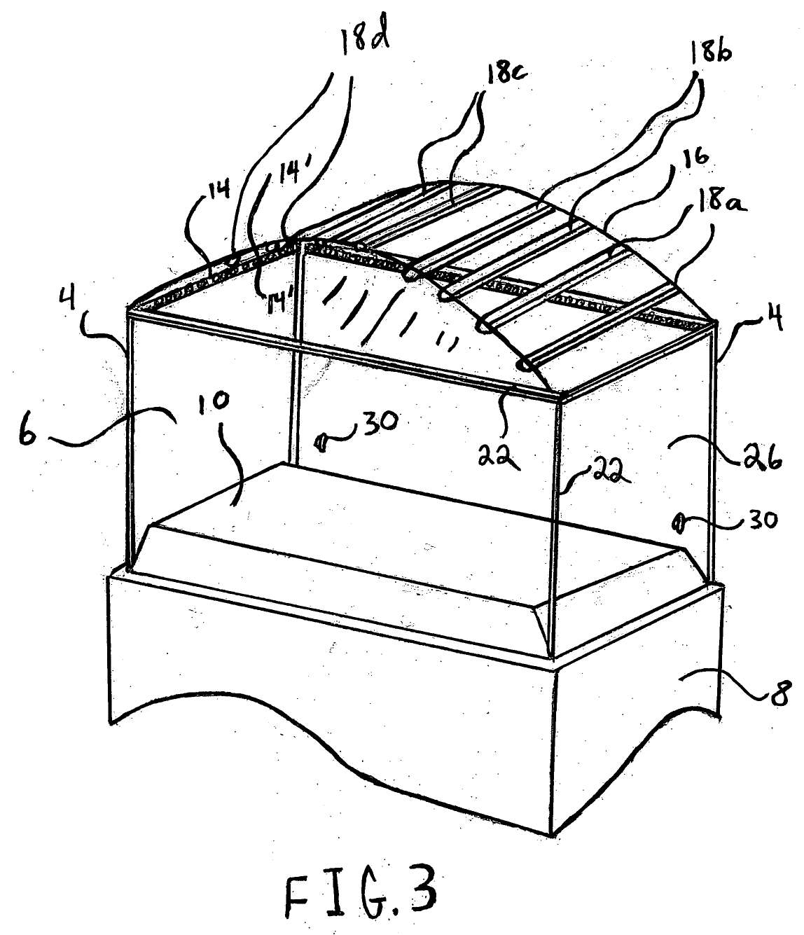

FIG. 3 shows an embodiment of the present invention having an overhead curved canopy 16 with overhead lights 18a, 18b, 18c, 18d. The overhead lights 18a-18d can be several types of lamps or light sources such as, inter alia, fluorescent lamps, lamps with metal halide bulbs or fiber optic light bars 14, such as those depicted in FIG. 4. The overhead lights 18a-18d can be positioned such that light emitted from the overhead lights 18a-18d reaches a tree 10′ on the platform 10.

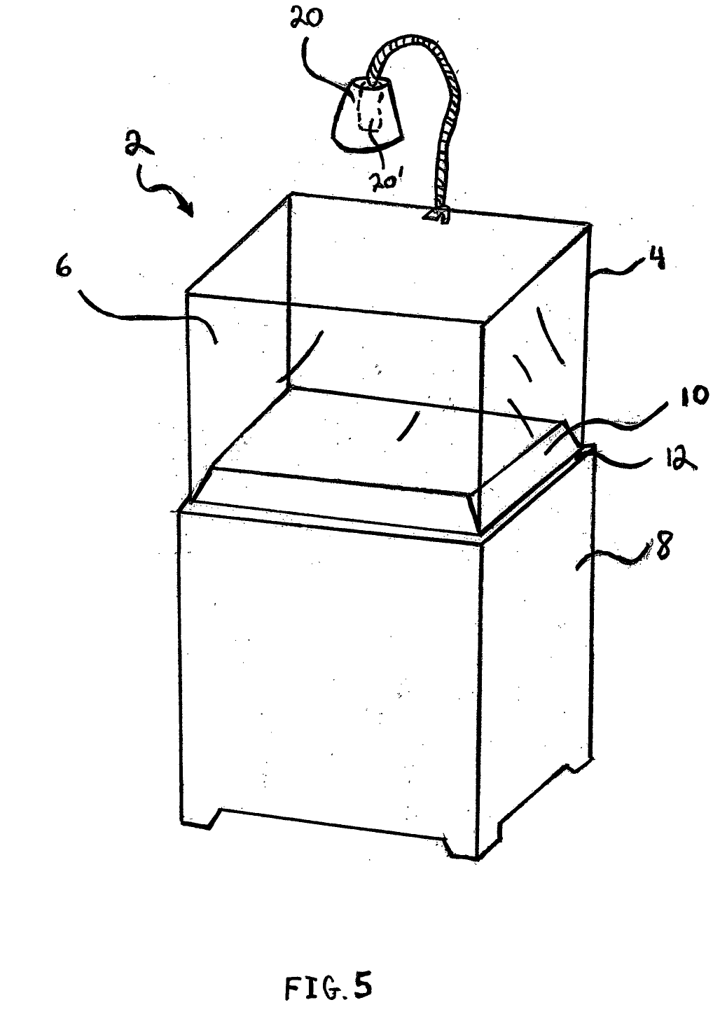

In other embodiments, an exterior light fixture 20 is provided. See FIG. 5. Like the overhead lights 18a-18d, the exterior light fixture 20 can have one or more various kinds of lamps 20′ connected thereto for emitting light. For example, in some embodiments, a fluorescent or metal halide lamp is connected to the exterior light fixture 20. In other embodiments, an optical fiber bundle can be connected to the exterior light fixture 20, which, in turn, can be connected to a separate light source 24. As described above for the embodiment of FIG. 1, the separate light source can be set apart and insulated from the display case.

Also, as can be seen in FIG. 2, one of the transparent walls 6 of the display case 4 can be a hinged wall 26 with hinges 28. The hinged wall 26 can be opened by grabbing handles 30 and pivoting the bottom of the hinged wall 26 upward, about the hinges 28 in the direction of arrow “A.” FIG. 2. A user of the display assembly 2 can open the display case 4 in this manner to remove or place a bonsai tree within the display case. As will be appreciated by one skilled in the art after reading this disclosure, several other configurations are possible for gaining access to an interior of the display case 4. For example, a top transparent wall 6′ could be liftable with a releasable lock device for locking the top transparent wall 6′ closed.

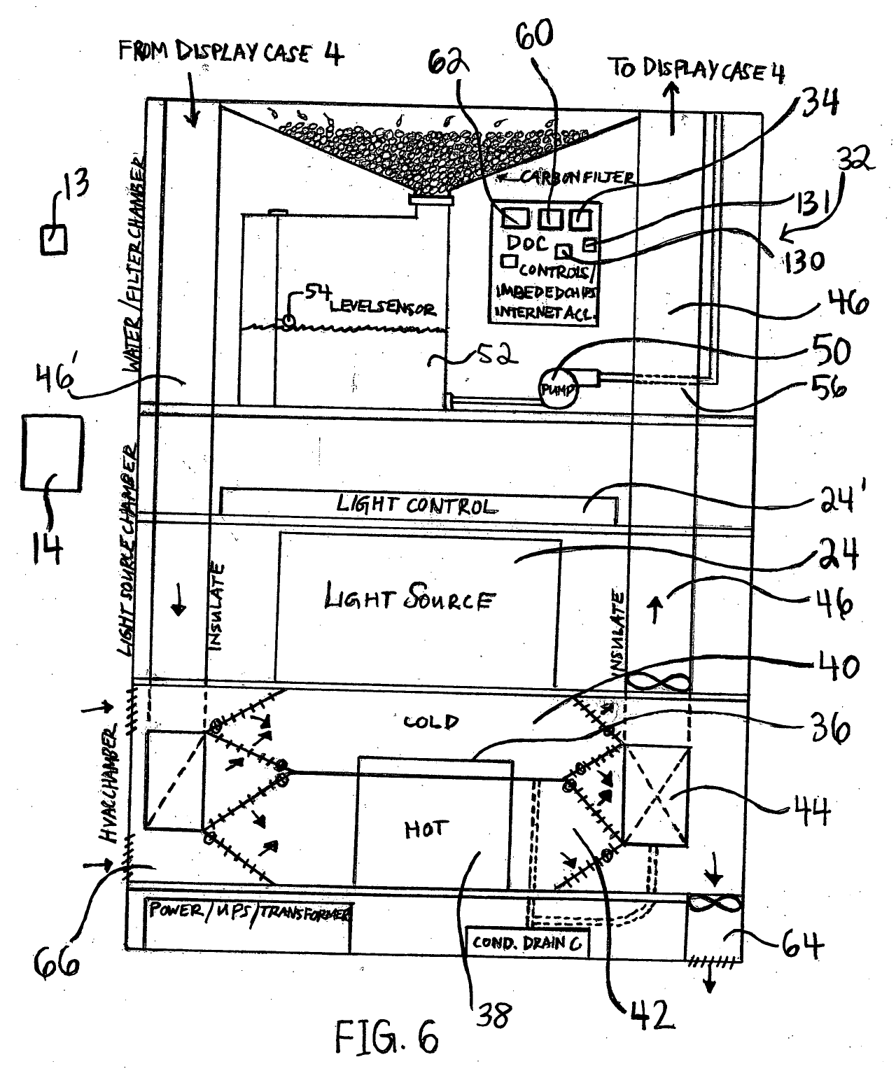

In some embodiments of the present invention, a climate control system 32 is provided, such as that shown in FIG. 6. The climate control system 32 can be configured to be powered by various sources of energy, such as, for example, battery cells or an AC wall plug. In the illustrated embodiment, the light source 24 is coupled to a light control 24′ that receives control signals from a processor 34 or controller. The light control 24′ can comprise a regulator for adjusting intensity of the light source 24. Alternatively, a combination of mechanical light control devices can be applied to dim, shutter or adjust color of the light, such as a mechanical system that selectively places colored lenses in front of a light source 24 to dim or affect the wavelength emitted therefrom.

In addition to the light control 24′, the climate control system also comprises a temperature control system in the illustrated embodiment. As can be seen in FIG. 6, a cooling member 36 and heating member 38 are provided. The cooling member 36 can be a thermoelectrically cooled surface. In such embodiments, heat can be “pumped” through the cooled surface to a heat sink. The heat sink can serve as a heating member 38.

The cooling member 36 can be in fluid communication with a cold side air conduit 40 and the heating member 38 can be in fluid communication with a hot side air conduit 42. The hot and cold side conduits 40 and 42 may converge at a flow control element 44, such as a damper or control valve. The flow control element 44 is, in turn, coupled to a downstream conduit 46, which has a discharge end coupled to the display case 4.

An upstream conduit 46′ is also provided. When a fan 47 is operated, air can circulate from the upstream conduit 46′, through the hot side 42 and cold side 40 conduits, to the downstream conduit 46, and then to the display case 4. In addition, a slipstream of air can be taken and discharged through a discharge opening 64. Also, an intake stream of fresh air can be taken through an inlet opening 66.

The flow control element 44 can be configured to selectively control the flow rate of air from the hot side conduit 42 and cold side conduit 40 into the downstream air conduit 46. The flow rates, or relative flow rates, of hot and cold air from the conduits 40, 42 can be controlled solely based on temperature within the display case 4. For example, one or more temperature sensors 48, (e.g. thermocouples), can be disposed within the display case at various locations. See FIG. 2. The temperature sensors 48 can be coupled to the processor 34 such that if the temperature within the display case rises beyond a preset control point in the display case 4, the processor 34 can selectively signal the flow control element 44 to increase cold air flow from the cold side conduit 40 into the downstream conduit 46. Conversely, if temperature falls below a desired temperature in the display case 4, the processor 34 can adjust the flow control element 44 to increase hot air flow from the hot side conduit 42 into the downstream conduit 46. A user can selectively program the control functions of the processor 34 to achieve different response times or to otherwise tune the temperature control.

In still further embodiments of the present invention, a humidifier is provided to control humidity within the display case 4. In the illustrated embodiment in FIG. 6, the humidifier comprises a pump 50, such as, but not limited to, a diaphragm, gear, or piston pump. A suction end of the pump 50 is coupled to a water reservoir 52 with a level sensor 54. The level sensor has an alarm of indicating high level and potential of flooding, or backing up into the display case or to indicate that water level is low and need to be refilled. In the case the alarm is trigged, a user can drain the water reservoir 52. A discharge end of the pump 50 is coupled to spray nozzles 56, such as atomizing injection nozzles. The spray nozzles 56 are disposed within the downstream air conduit 46. As air flows downstream in the downstream air conduit 46, toward the display case 4, the pump 50 can inject water from the reservoir 52 into the air, humidifying the air. One or more humidity sensors 58 can be disposed at various locations within the display case 4. See FIG. 2. The humidity sensors 58 can be coupled to the processor 34 to send an input signal to the processor 34 containing information about humidity in the display case 4. The processor 34 can then control the pump 50 based on a preprogrammed humidity control algorithm or function with a humidity set point. For example, if the humidity in the display case 4 is below a set point, the processor 34 can signal the pump 50 to start or increase water flow to the downstream air conduit 46. The set point will depend on the particular application. Also, the locations of each of the components can vary.

In some embodiments of the present invention having the curved canopy 16 and overhead lights 18a-18d, the overhead lights are coupled to the processor 34. The processor 34 can be coupled to a regulator used to control intensity of each of the overhead lights 18a-18b independently. In some embodiments, the processor 34 regulates power to the overhead lights 18a-18d based on a preprogrammed timer. For example, the processor 34 can turn on some of the overhead lights (e.g. 18a and 18b) at certain times of day, and shut off or dim others (e.g. 18c and 18d) during that time. At another time during the day, all overhead lights (e.g. 18a-18d) can be on at lower than maximum intensity. Still at another time of the day, some overhead lights (e.g. 18d) could be on at full intensity while the remaining overhead lights (e.g. 18a-18c) could be off. As will be appreciated by one skilled in the art after reviewing this disclosure, there exist a myriad of possible control configurations for controlling the overhead lights 18a-18d. The flexibility of independent control of each overhead light 18a-18d or even groups of overhead lights, can be utilized to imitate the position and intensity of the sun during a day.

In yet further embodiments of the present invention, the climate control system 32 has at least a first communication port 60 coupled to a communication system or network, such as, for example, the Internet. The first communication port 60 is also coupled to the processor 34. Data in a suitable format from the Internet can be read by the processor 34 and converted into input data for controlling the climate control system 32. For example, a remote temperature sensor can be placed in a remote location from which a subject bonsai tree (or other plant) originated or where the subject bonsai tree grows naturally. The location may be a region with a significantly different climate than a present climate where the subject bonsai tree is displayed. The remote temperature sensor can be coupled to a signal converter for converting a signal from the temperature sensor to a suitable signal for transferring over the Internet. In turn, the signal from the signal converter can be transferred over the Internet. The climate control system 32 and processor 34 can receive the remote temperature measurement via the Internet. The temperature measurement can then be used as a set point to control temperature with the climate control system 32. Alternatively, a set point in the climate control system 32 can be a function of the remotely obtained temperature measurement. As will be appreciated by one skilled in the art after reviewing the present disclosure, other climate variables or parameters such as pressure, wind direction, wind velocity, humidity, and light intensity can also be measured and communicated from remote locations through the Internet to the climate control system 32 for use as a set point or other input variable for controlling the climate control system 32. In this way, the climate conditions within the display case 4 can mimic, simulate or be affected by the climate conditions of a remote area.

In some embodiments, various remote light intensity sensors are placed in different positions about a remotely located plant. Each of the remote light intensity sensors is coupled to a communication network to which the climate control system 32 is coupled. The climate control system 32 receives signals from each of the plurality of light intensity sensors. Each of the signals can be selectively used to control intensity of different ones of a plurality of lights, such as the overhead lights 18a-18d.

Some embodiments of the present invention include a Web Site or portal having live feed (i.e., real time or dynamic) climate data from various regions of the world. As previously stated, at least a first communication port 60 of the present invention can be coupled to a communication system such as the Internet. Software either stored in an internal memory 62 of the climate control system 32 or accessed through a Web Site is configured to allow climate data from the Web Site to be readable by the climate control system 32. Also, conditions inside the display case can be uploaded back to the Web Site so that they can also monitored remotely. The climate data can then be used for setting set points or other inputs to the climate control system 32, as discussed above. A user of the Web Site and climate control system 32 can select any set of data for download from the various regions of the world. In some embodiments, the user can combine data from the various regions to control the climate control system 32.

In addition, historical climate data could be downloaded from the Web Site for a plurality of regions. The historical climate data could be stored in the internal memory 62 of the climate control system 32 for use as inputs to control the climate control system 32. Also, the climate control system can have a receiving device 130 for receiving and reading computer-readable media 13. Historical climate data could also be provided on computer readable media 13 including, but not limited to, floppy disks, CD-ROM disks, tapes, flash memory, system memory, DVD-ROM, or hard drives.

In addition, it is noted that certain embodiments of the invention have at least a second communication port 131 for communicating with an external computer 14 for use in providing input data to the control system 32 or for exporting data for analysis to the external computer 14.

Although specific embodiments and examples of the invention have been described supra for illustrative purposes, various equivalent modifications can be made without departing from the spirit and scope of the invention, as will be recognized by those skilled in the relevant art after reviewing the present disclosure. The various embodiments described can be combined to provide further embodiments. The described devices and methods can omit some elements or acts, can add other elements or acts, or can combine the elements or execute the acts in a different order than that illustrated, to achieve various advantages of the invention. These and other changes can be made to the invention in light of the above detailed description.

In general, in the following claims, the terms used should not be construed to limit the invention to the specific embodiments disclosed in the specification. Accordingly, the invention is not limited by the disclosure, but instead its scope is determined entirely by the following claims.

What is claimed is:

1. A plant display system comprising:
a display case having a transparent wall for viewing a plant disposed within the display case;
a climate control system for controlling at least one climate parameter within the display case, the climate control system having at least a first communication port that is coupled to a communication network; and
a remote sensor positioned at a remote location for measuring at least one climate parameter at the remote location, the remote sensor being coupled to the communication network to provide climate data through the communication network to the climate control system.

2. The plant display system of claim 1 where the climate control system comprises a heating member and a cooling member for controlling temperature within the display case and wherein the remote sensor measures temperature at the remote location.

3. The plant display system of claim 1 wherein the climate control system comprises an air flow control system for controlling air flow through the display case and wherein the remote sensor measures at least one of wind speed and wind direction at the remote location.

4. The plant display system of claim 1 wherein the climate control system comprises an adjustable humidifier and wherein the remote sensor measures humidity at the remote location.

5. The plant display system of claim 1 wherein the climate control system comprises an adjustable light source for controlling light intensity in the display case and wherein the remote sensor measures light intensity at the remote location.

6. The plant display system of claim 1 wherein the climate control system comprises at least two adjustable light sources for controlling the light intensity at various positions within the display case.

7. The plant display system of claim 1 wherein the climate control system comprises an plurality of adjustable light sources for controlling light intensity in the display case and wherein there are a plurality of remote sensors that measure light intensity a different positions in relation to a plant located at the remote location, said different measurements being used to control said plurality of adjustable light sources.

8. A plant display system comprising:
a cabinet;
a display case disposed above the cabinet, the display case having a transparent wall for viewing a plant disposed within the display case;
a climate control system at least partially disposed within the cabinet for controlling at least temperature within the display case, the climate control system comprising:
a hot air conduit in fluid communication with a heating member;
a cold air conduit in fluid communication with a cooling member;
a low heat lighting element positioned in at least one of a position on a frame of the display case and above the display case;
a light source for providing light to the low heat lighting element, said light source being positioned apart from the display case; and
a fan for circulating air through the display case.

9. The plant display system of claim 8 further comprising overhead lights positioned on an curved overhead canopy of the display case.

10. The plant display system of claim 9 wherein the light intensity of each of the overhead lights is controllable independently or in groups.

11. The plant display system of claim 8 wherein the climate control system comprises an adjustable humidifier.

12. The plant display system of claim 1 wherein the light source is adjustable for controlling light intensity in the display case.

13. A method of displaying a plant comprising:
providing a display case for containment of a plant;
providing a climate control system coupled to the display case to control climate within the display case;
receiving at least one of real time and historical climate data from a remote location through a communication network; and
adjusting a control variable of the climate control system based on the climate data received from the remote location.

14. The method of claim 13 wherein the climate data comprises temperature measurements from the remote location.

15. The method of claim 14 further comprising controlling a hot air and cold air flow rate as a function of the temperature measurements.

16. The method of claim 13 wherein the climate data comprises humidity measurements.

17. The method of claim 16 further comprising adjusting a water flow rate based on the humidity measurements.

18. The method of claim 13 wherein the climate data comprises light level measurements.

19. The method of claim 18 further comprising adjusting a light level in the display case as a function of the light level measurements.

20. The method of claim 13 further comprising providing a low heat lighting element with a light source positioned apart form the display case to lower heat load within the display case.
